(19) United States
(12) Patent Application Publication
(10) Pub. No.: US 2018/0100319 A1
(43) Pub. Date: Apr. 12, 2018

(54) MOBILE KIOSK

(71) Applicant: Ports America Group, Inc., Jersey City, NJ (US)

(72) Inventors: Brian Eldon Murley, Gig Harbor, WA (US); Matthew David Riggsby, Buckley, WA (US); Jonathan Lee Pierce, Olympia, WA (US); H. Lawrence Yang, Artesia, CA (US)

(73) Assignee: Ports America Group, Inc., Jersey City, NJ (US)

(21) Appl. No.: 15/703,043

(22) Filed: Sep. 13, 2017

Related U.S. Application Data
(60) Provisional application No. 62/405,553, filed on Oct. 7, 2016.

(51) Int. Cl. E04H 1/12; H02J 7/00; E04H 1/14

(52) U.S. Cl. CPC E04H 1/1227; G06Q 50/30; E04H 1/14; H02J 7/0003

(57) ABSTRACT

A mobile kiosk may house a configured to receive commands to control the mobile kiosk. The mobile kiosk may include an enclosed space housing at least a portion of the circuit and a base supporting the enclosed space. The mobile kiosk may be configured to be movable.

### CROSS-REFERENCE TO RELATED APPLICATION

This application is based on and derives priority from U.S. Provisional Patent Application No. 62/405,553, filed Oct. 7, 2016, the entire contents of which are incorporated by reference herein.

### BRIEF DESCRIPTION OF THE DRAWINGS

FIG. 1A is a front elevational view of a mobile kiosk according to an embodiment of the invention.

FIG. 1B is a perspective view of a rear and side of a mobile kiosk according to an embodiment of the invention.

FIG. 1C is a perspective view of a side and base of a mobile kiosk according to an embodiment of the invention.

FIG. 1D is a perspective view of a ballast tray of a mobile kiosk according to an embodiment of the invention.

FIG. 1E is a perspective view of a battery tray of a mobile kiosk according to an embodiment of the invention.

FIG. 1F is a front elevational view of a mounting plate of a mobile kiosk according to an embodiment of the invention.

FIG. 1G is a perspective view of a lower section of a mobile kiosk according to an embodiment of the invention.

FIG. 1H is a perspective view of an upper section of a mobile kiosk according to an embodiment of the invention.

FIG. 2 is a schematic of an electronic system of a mobile kiosk according to an embodiment of the invention.

FIG. 3 is a layout drawing of a mobile kiosk according to an embodiment of the invention.

FIG. 4 is a logic drawing of a power supply, storage, and distribution system according to an embodiment of the invention.

FIGS. 5A-5E are logic drawings illustrating interconnections between mobile kiosk electronic systems according to an embodiment of the invention.

FIG. 6 is a block diagram of mobile kiosk circuitry and external kiosk operating system circuitry according to an embodiment of the invention.

### DETAILED DESCRIPTION OF SEVERAL EMBODIMENTS

Kiosk and/or gate systems may be employed for traffic control. A mobile kiosk may be repositioned and/or relocated without new construction to adapt traffic control to changing situations, such as changes in facility layout (e.g., in intermodal container handling facilities or distribution centers), changes in projected traffic flows, changes in flows of equipment and traffic patterns, or the like. The mobile kiosk may be self-contained, so that fixed mounting installations (e.g., concrete poured bases), as well as fixed conduit connections to power and/or communications networks, may not be necessary. For example, the mobile kiosk may utilize wireless technologies such as WiFi, Cellular/LTE/4G/5G, and satellite for communications and may use environmental friendly/neutral (e.g., solar, wind turbine, water turbine, fuel cell, etc.) power sources to supply power for operations. Accordingly, the mobile communications kiosk may be relocated without new construction

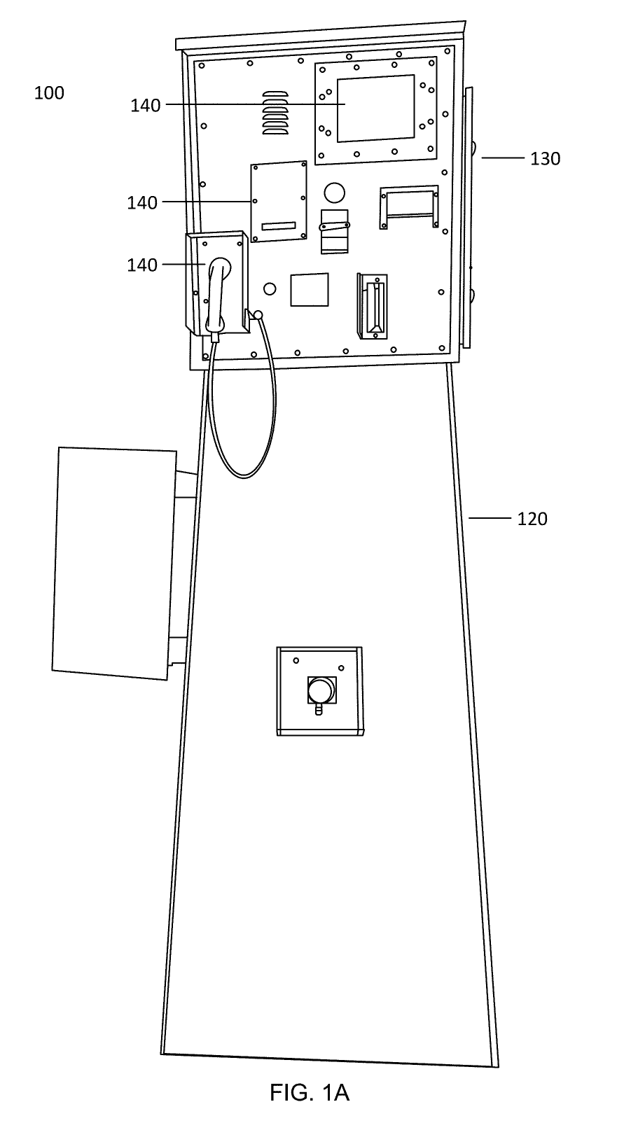

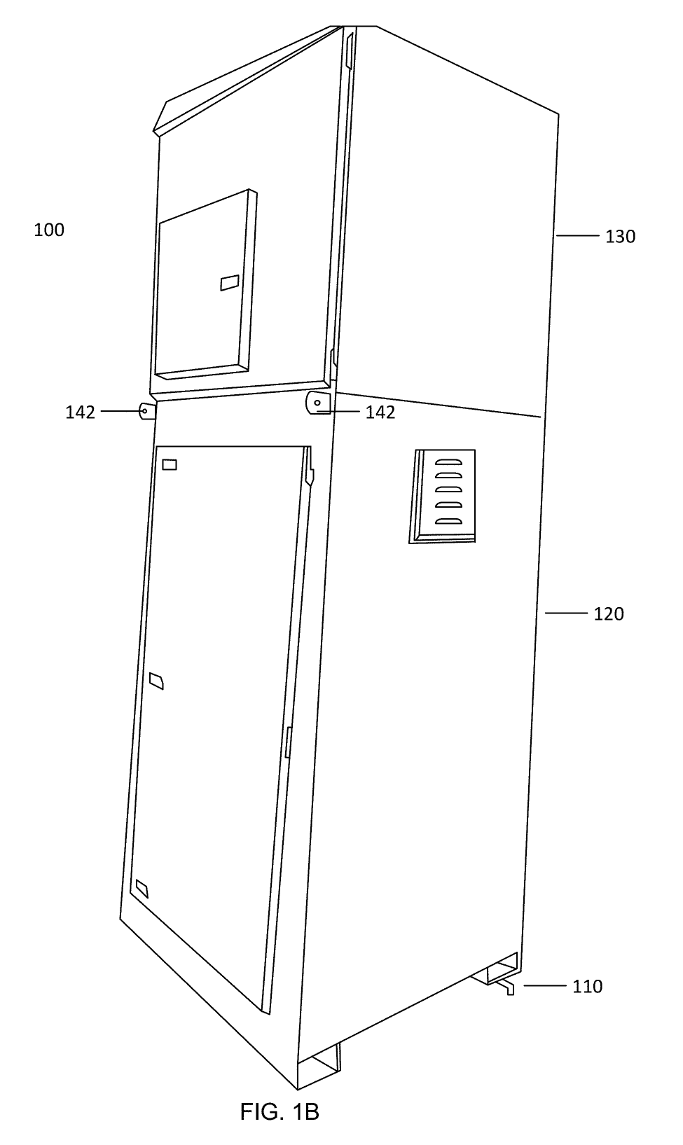

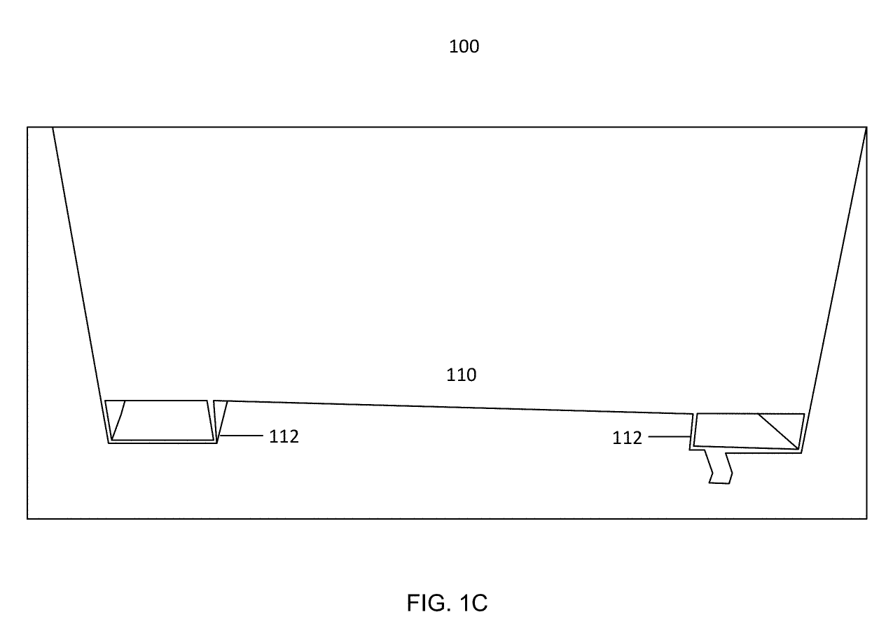

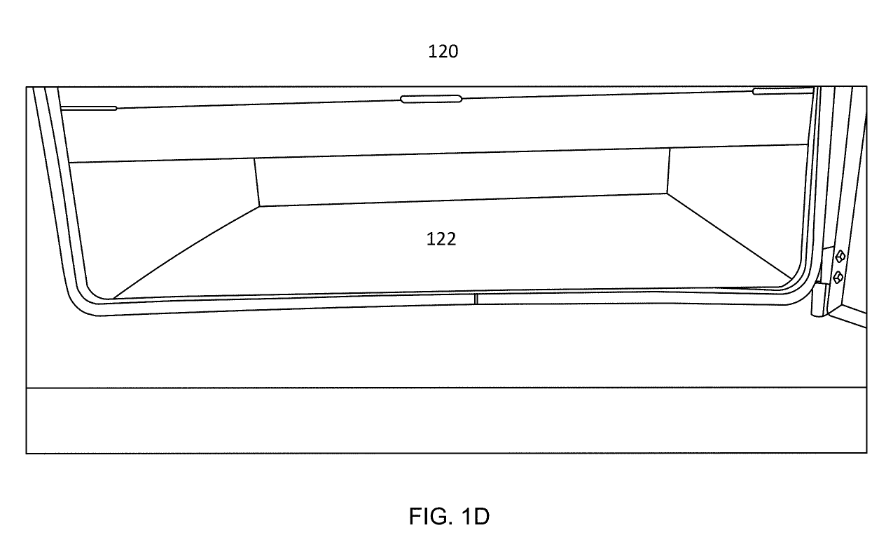

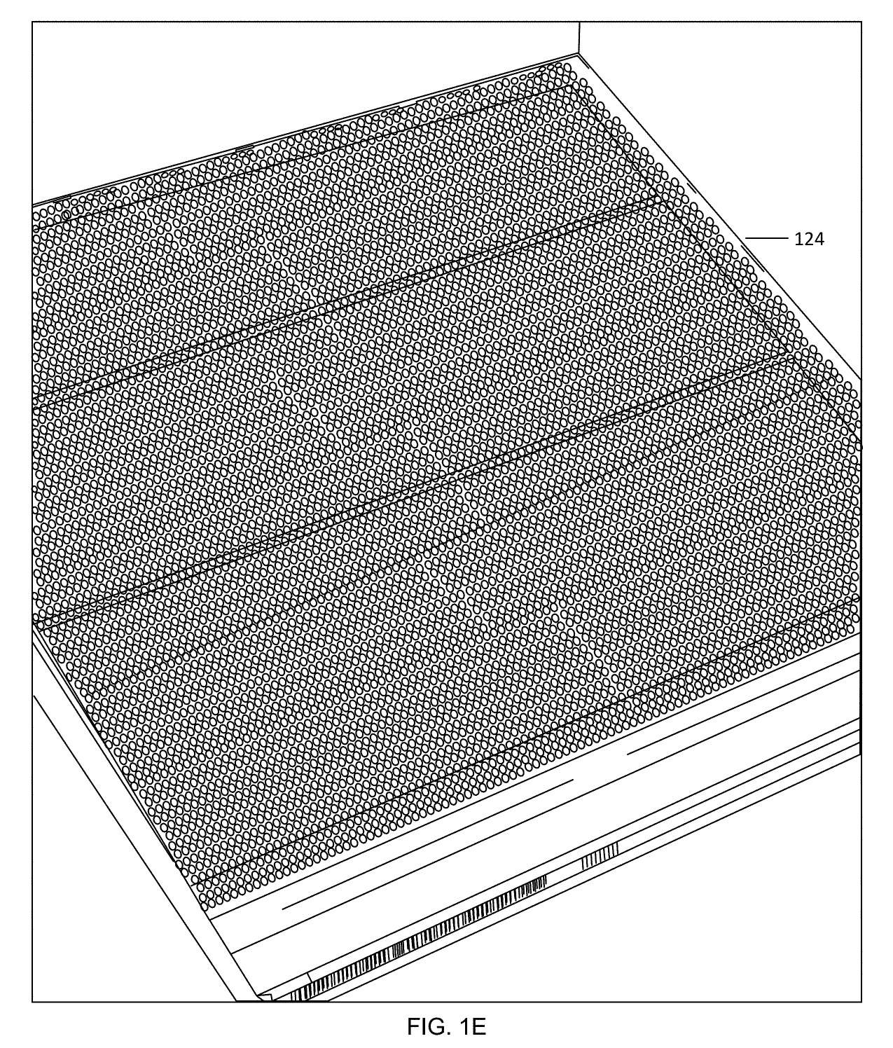

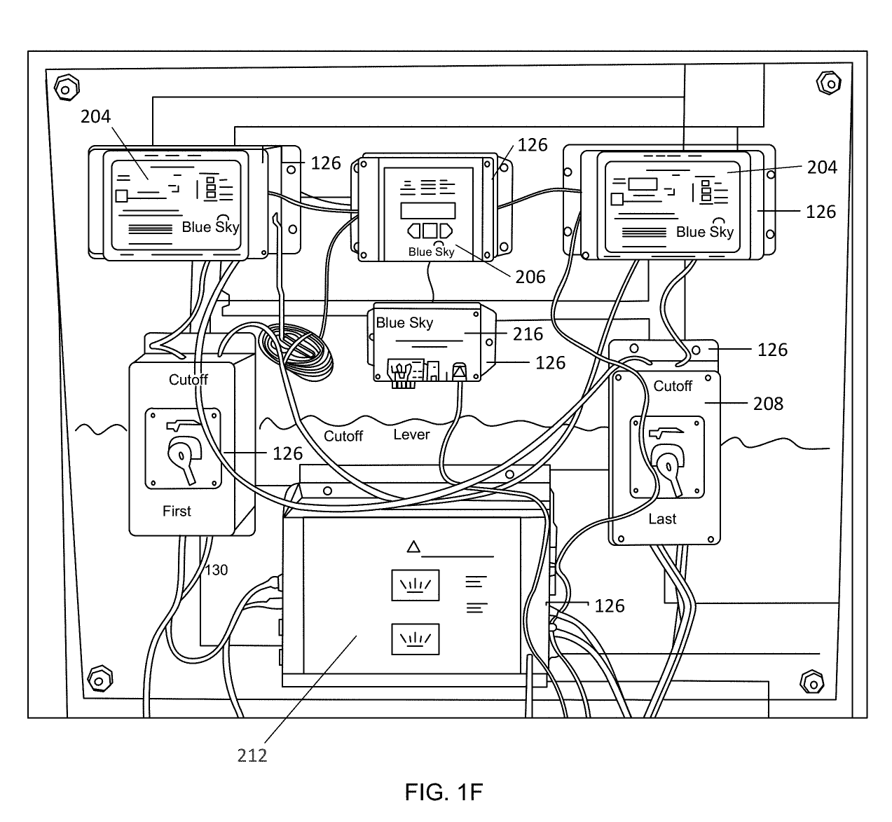

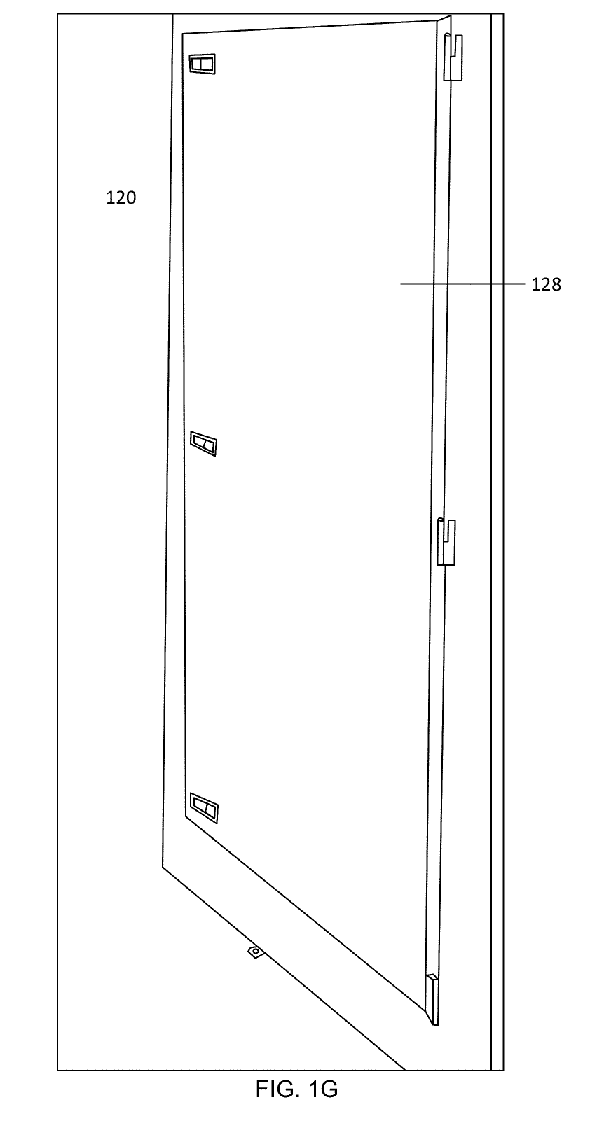

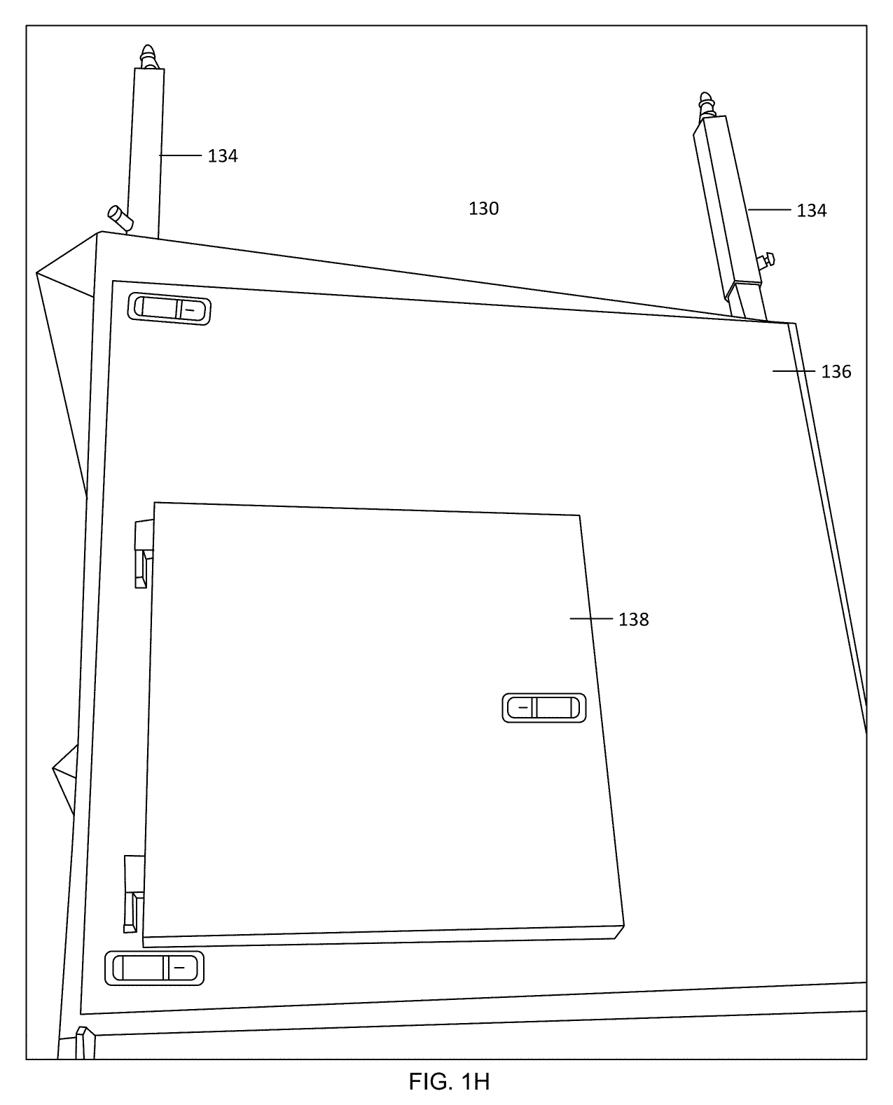

FIGS. 1A-1H illustrate a mobile kiosk 100 according to an embodiment of the invention. The mobile kiosk 100 may be a single unit divided into sections to isolate equipment based on use and need. As shown in FIGS. 1A and 1B, the mobile kiosk may include a base 110, a lower section 120, and an upper section 130, for example.

As shown in FIG. 1C, the mobile kiosk 100 may include lifting points 112 at the base 110 for easy relocation through use of lifting equipment (e.g., pallet jack or forklift). These lifting points 112 may also provide a solid footing for the entire enclosure 100.

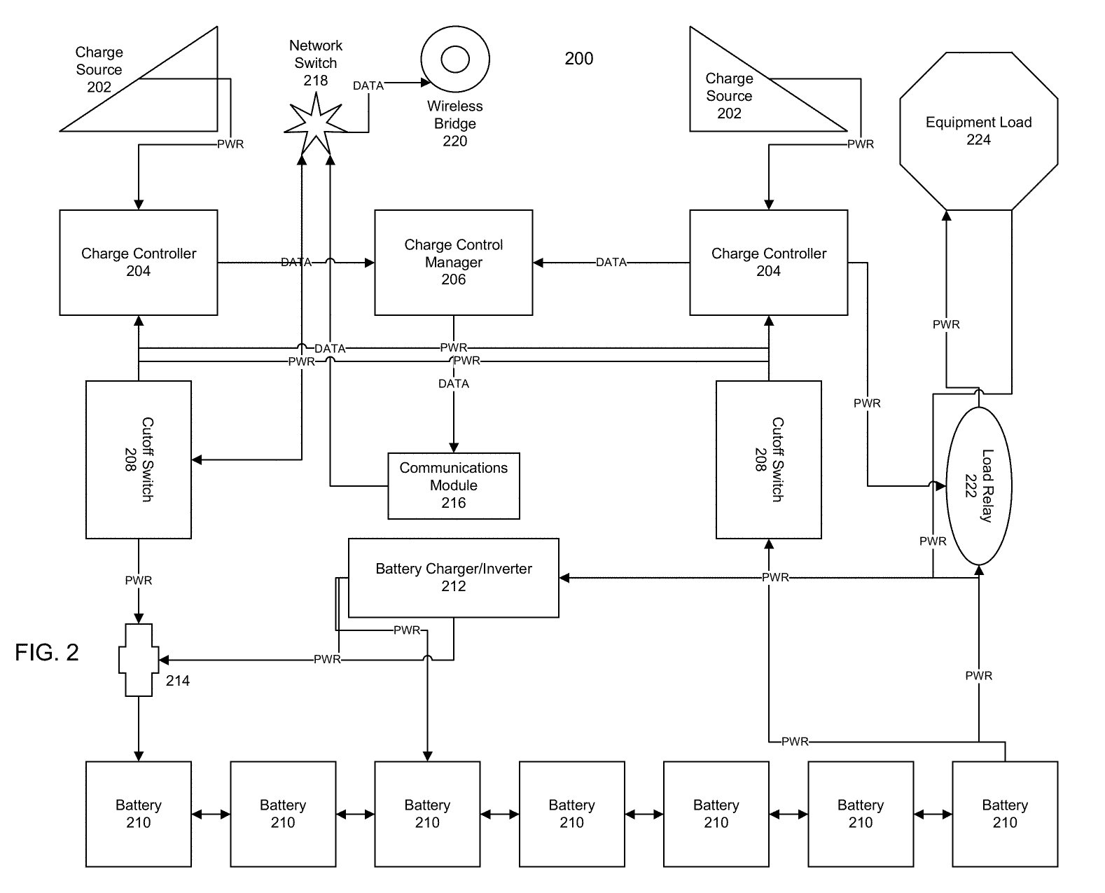

The lower section 120 may contain a ballast area 122 as shown in FIG. 1D, a battery tray 124 as shown in FIG. 1E, and mounting plates 126 for installation of electrical control and/or power source equipment as shown in FIG. 1F. The electronics may include, for example, charge controllers 204, charge control managers 206, cutoff switches 208, inverters 212, communications modules 216, network switches 218, wireless bridges 220, and/or load relays 222 (see also FIG. 2). The electronics in the mobile kiosk 100 may receive primary power from batteries in the battery tray 124. Supplemental power may be provided through green and/or renewable energy sources 202 such as PV solar panels, wind turbines, water turbines, or fuel cell. Auxiliary power may also be provided from external electrical sources including generator or shore power 214 which may be converted and supplied into the system using an integrated inverter 212. The power systems may include components to regulate, monitor, and charge the batteries and may allow for remote monitoring of the power system over the communications systems contained within the mobile kiosk 100 through use of a monitoring interface. Battery charging may be accomplished through use of charge controllers 204 connected to a charging source 202. These sources may include the green energy sources (e.g, PV solar panels, wind turbine, water turbine, or fuel cell) and/or external sources. When using an external source such as a generator or shore power to charge the system, charge controllers 204 may be bypassed, and charging may be controlled by the inverter 212 itself.

The upper section 130 may contain network communications equipment (e.g., IP switches 218, network bridges 220, modems 216, and/or other communications equipment). The network communications equipment may utilize wireless technologies to transmit data, audio, and video for use in the gate systems to support operations, as discussed in greater detail below. The upper section 130 may also include mounting locations 132 for installation of gate systems equipment to support a gate system implementation by outside vendors, as shown in FIG. 1A.

The top of the mobile kiosk 100 may include mounting points 134 for solar panels, wind turbines, or water turbines with cabling to the lower section to provide charging power to the power supply system, as shown in FIG. 1H.

The mobile kiosk 100 may include locking doors providing access to the inside of the enclosure 100. For example, the mobile kiosk 100 may include a door 128 with access to the entire lower section 120 of the pedestal, as shown in FIG. 1G, and a door 136 with access to the entire upper section 130 of the pedestal, as shown in FIG. 1H. The mobile kiosk 100 may also include a smaller door 138 providing limited access to the upper section 130 of the pedestal, as shown in FIG. 1H.

Access for interface with truckers may be accomplished through the front of the mobile kiosk 100. The mobile kiosk 100 may include one or more openings 140 to support installation of intercom, telephone handset, barcode scanner, printer, RFID systems, cameras, and/or other data/audio/video communications systems, as shown in FIG. 1A.

Mounting points 142 may be included on the side of the mobile kiosk 100 to allow for installation of a ladder and platform to allow maintenance access to the upper section of the mobile kiosk 100 while it is in place. See FIG. 1B. The mounting points 142 may allow a user to easily remove or reinstall the ladder and platform to allow access to the lower section 120 of the mobile kiosk 100 while it is in place.

FIG. 2 is a schematic of an electronic system 200 of a mobile kiosk 100 according to an embodiment of the invention. The system 200 may include one or more charge sources 202, for example PV solar panels, wind turbines, or water turbines, configured to generate electricity for the system 200 independently of a power grid. The system 200 may include one or more batteries 210 that may store power generated by charge sources 202 and power other system 200 components. Charge controllers 204 may regulate the flow of current from charge sources 202 to batteries 210 and may be managed by charge control manager 206. The system 200 may also receive power from external power sources 214 (e.g., a generator or shore power). In this case, inverter 212 may convert the external current and directly charge the battery system and maintain power for the equipment loads. Cutoff switches 208 may be opened to deactivate system 200 for maintenance or other purposes.

System 200 elements powered by batteries 210 and/or external sources 214 may include equipment load 224 (e.g., gate equipment such as a gate motor, signals, etc.). Equipment load 224 may be controlled by load relay 222. System 200 elements powered by batteries 210 and/or external sources 214 may also include network switch 218, and wireless bridge 220. These communication elements may send equipment status and other data and may receive commands to operate the equipment.

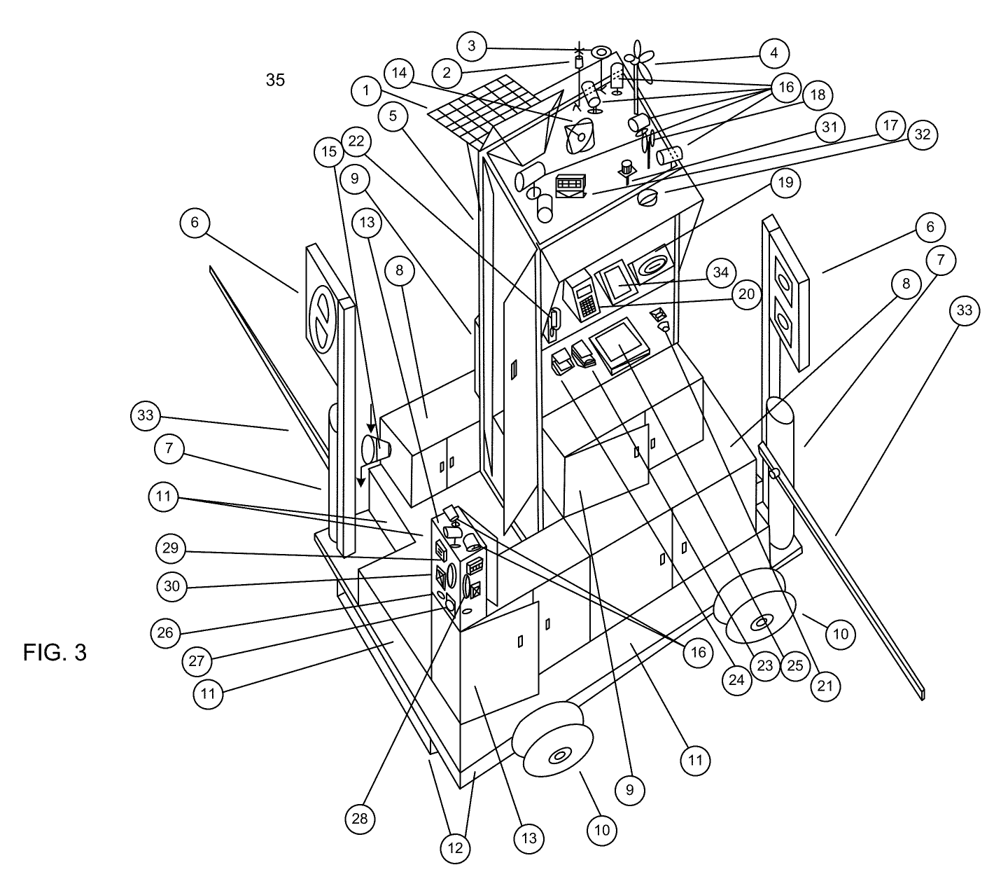

FIG. 3 is a layout drawing of another mobile kiosk embodiment according to an embodiment of the invention. FIGS. 1A-1H and 3 show different physical mobile kiosk embodiments, but those of ordinary skill in the art will appreciate that specific features of each illustrated embodiment may be provided in different combinations to form additional embodiments. For example, the ladder mounting points of FIGS. 1A-1H and the wheels of FIG. 3 may both be present in a single embodiment.

The mobile kiosk of FIG. 3 may be a single unit with divided sections to isolate equipment based on use and need in some embodiments. The mobile kiosk 35 of FIG. 3 may include one or more charge sources such as solar panels 1, wind turbine 4, rain water turbine 15, and/or other sources. The charge sources may be coupled to power generation and distribution control circuitry disposed in power generation/control-distribution/storage system compartment 9. Power generated by the charge sources may power other components of the mobile kiosk 35 and/or may be stored in batteries in battery compartment 11.

Mobile kiosk 35 may utilize a power storage system, power supply system, and power distribution system, controlled by a power management and monitoring system. These systems may be contained within mobile kiosk 35. The power storage system may be enclosed within the base of the kiosk or within compartment 11 depending on installation needs. The power management and monitoring system may be installed within the same compartment as the storage system or may be installed into another compartment with other equipment as needed.

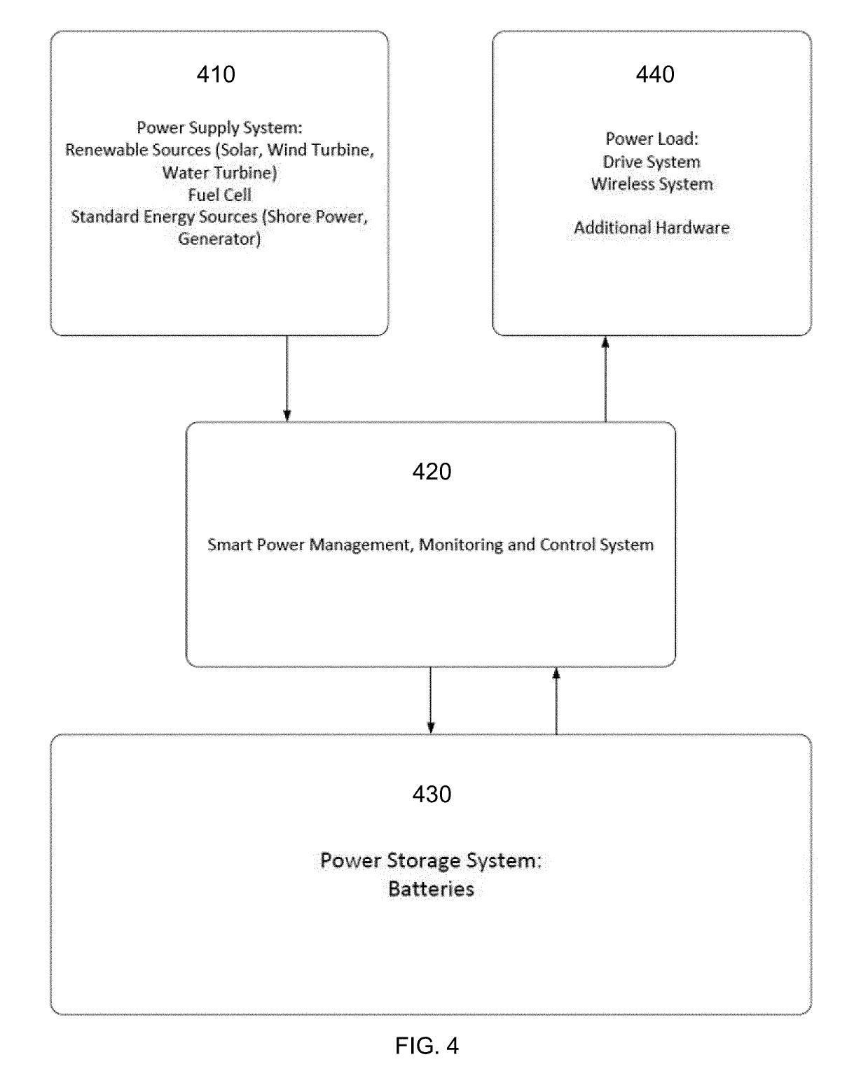

The power storage system may provide a primary source of power to the equipment attached to the distribution system (e.g., the other electronic equipment of mobile kiosk 35 described herein). The power storage system may be monitored and controlled by the management and monitoring system. The management and monitoring system may control the recharge of the power storage system and may charge the storage system through an external power supply (e.g., solar panels 1, wind turbine 4, rain-water turbine 15, or other power sources as described above). The power distribution system may include components to regulate the flow of electricity and may include methods to disconnect the distribution system from the power source for maintenance and repair. For more details about connections between power storage system, management and monitoring systems, power sources, and power-drawing loads, see FIG. 4.

In some embodiments, mobile kiosk 35 may include communication elements such as network antenna 2, GPS antenna 3, communication circuitry disposed in HMI-OCR-RFID-GPS-Network system and control cabinet 5, satellite dish antenna 14, and/or other elements.

Mobile kiosk 35 may include user interface elements for providing user communications, traffic signaling, and the like. For example, mobile kiosk 35 may include red-green entrance-exit traffic control lights 6, gate actuator 7, camera for facial identification and visual communication 19, key pad 20, push buttons 21, voice over IP (VOIP) phone 22, card reader (e.g., for reading smart cards, transportation worker identity cards (TWIC), and/or credit cards) 23, barcode scanner 24, near field communication (NFC) input device 25, radio frequency (RF) reader 32, gate arm 33, touchscreen 34, and/or other elements. Communication elements (e.g., camera 19, key pad 20, push buttons 21, phone 22, card reader 23, barcode scanner 24, NFC device 25, RF reader 32, touchscreen 34) may be used to communicate or relay information to an operator located away from the kiosk and/or (e.g, in the case of the touchscreen) interact directly with systems of mobile kiosk 35 without communicating with the operator.

Mobile kiosk 35 may include drive control and operation elements such as drive circuitry disposed in drive and powertrain system compartment 8 (e.g., including drive motors), drive wheels 10 or drive tracks (e.g., which may be driven by the drive equipment in drive and powertrain system compartment 8 and/or provide a solid footing for the kiosk 35), chassis with forklift pickup points 12 (e.g., which may engage with lifting equipment and/or provide a solid footing for the kiosk 35), system and control center for drive system proximity sensing/access control/sensing/alarming 13, cameras for drive sensing/monitoring/controlling (which may also be used for optical character recognition (OCR), e.g., of signs) 16, LED light (e.g., serving as a headlight and/or spotlight) 17, horn 18, infrared (IR) sensors for proximity sensing and drive safety 26, magnetic sensor for proximity sensing 27, lasers for proximity sensing and driving safety 28, motion detectors for proximity sensing and drive safety 29, acoustic sensors for proximity sensing and drive safety 30, and/or yellow/red strobe warning/alarm safety lights 31, and/or other elements. Mobile kiosk 35 may contain an area for inclusion of ballast to maintain a low center of gravity for the entire unit, as discussed above.

Mobile kiosk 35 may include mounting points for equipment to be installed into mobile kiosk 35 as needed. Some elements discussed above may be removably mounted to mobile kiosk 35 at mounting points. Examples of equipment that may be mounted on mobile kiosk 35 may include network antenna 2 (e.g., including 802.11 and/or Cellular/LTE/4G/5G), GPS antenna 3, traffic control lights 6, traffic control arm 7, and/or satellite antenna 14.

The mobile communications kiosk may include access doors in various locations allowing maintenance/repair access to components installed within internal compartments. The mobile communications kiosk may also include external attachment points to allow additional hardware to be installed for maintenance use (e.g., attaching a semi-permanent ladder to the unit for quick maintenance access)

FIG. 4 is a logic drawing of a power supply, storage, and distribution system according to an embodiment of the invention. Renewable power sources 410 (e.g., solar panels 1, wind turbine 4, rain water turbine 15, and/or other sources) may generate power. In some embodiments, power may be supplied by other power sources (e.g., external sources such as a power grid or generator coupled to mobile kiosk 35 as discussed above). Power control circuitry 420 may receive the power generated by renewable power sources 410 and/or other power sources. Power control circuitry 420 may route some or all of the power to storage system (e.g., one or more batteries) 430. Power control circuitry 420 may route some or all of the power to load (e.g., drive system, communications system, etc.) 440.

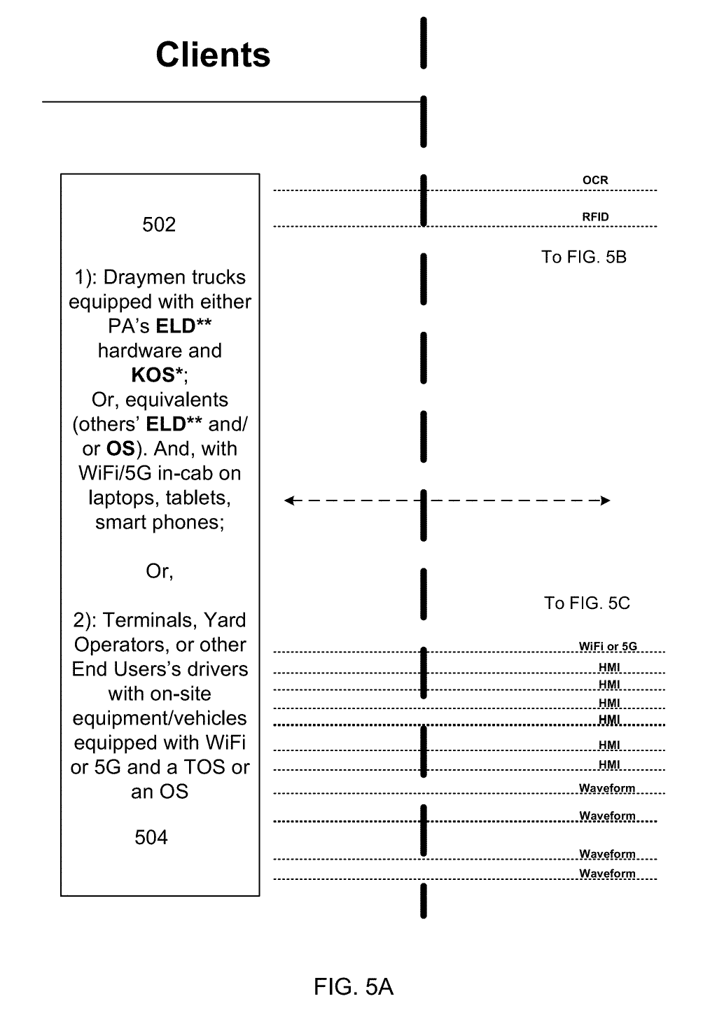

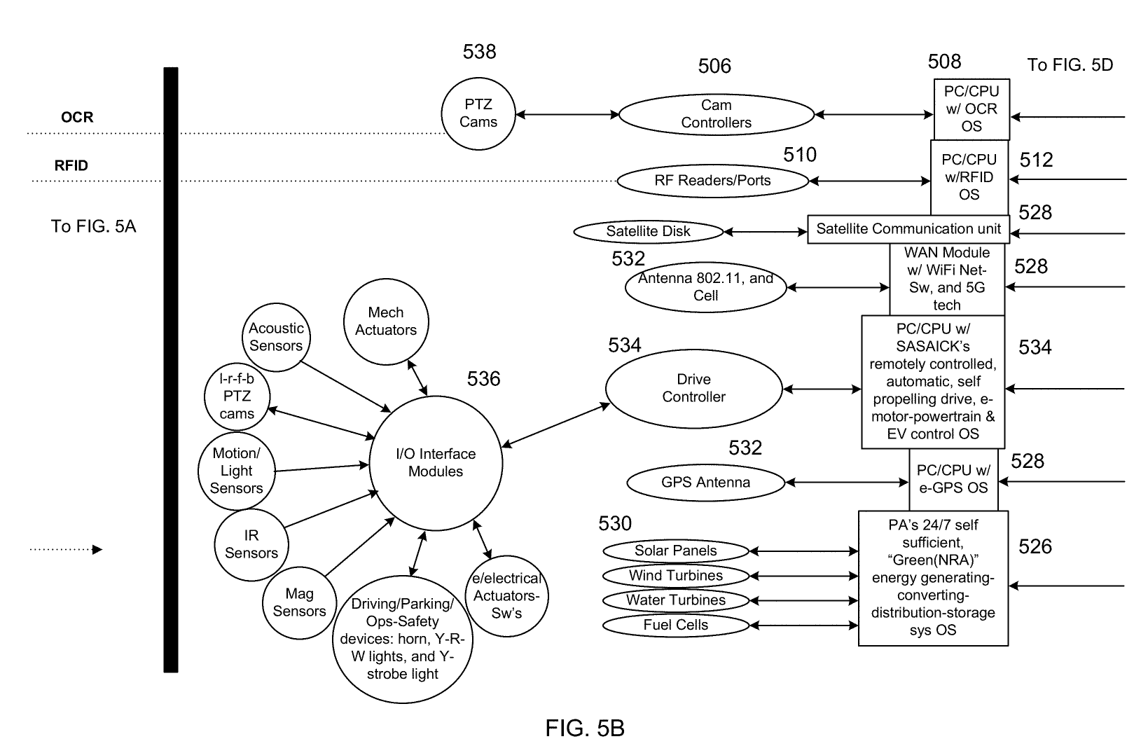

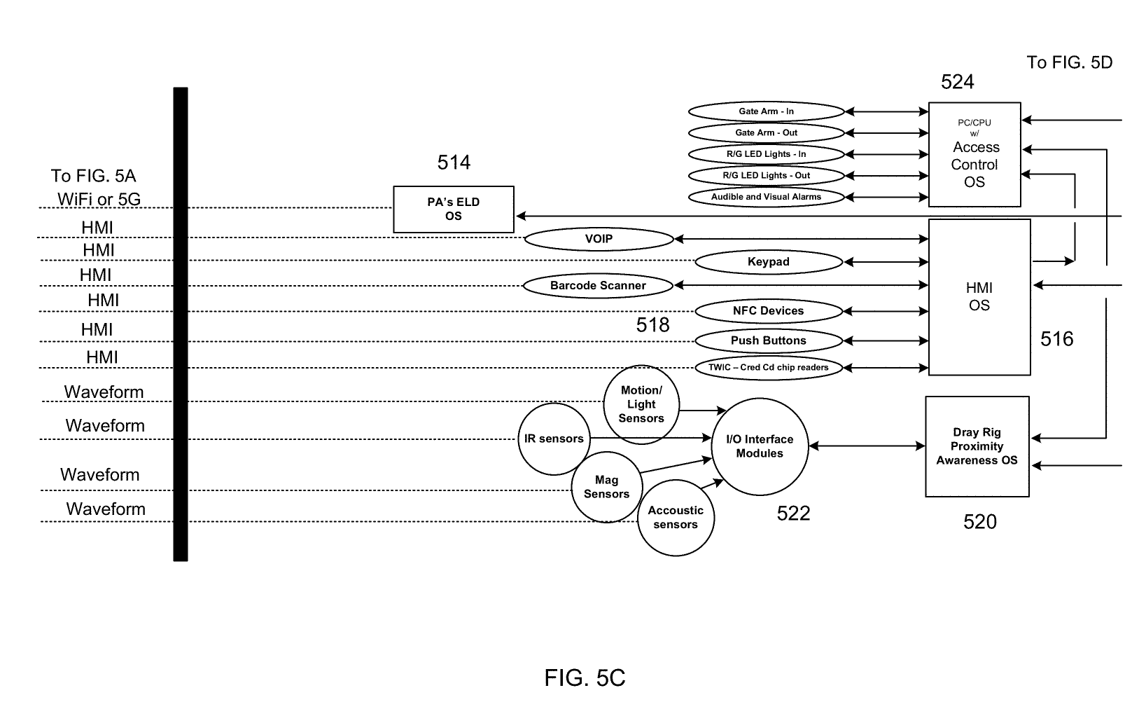

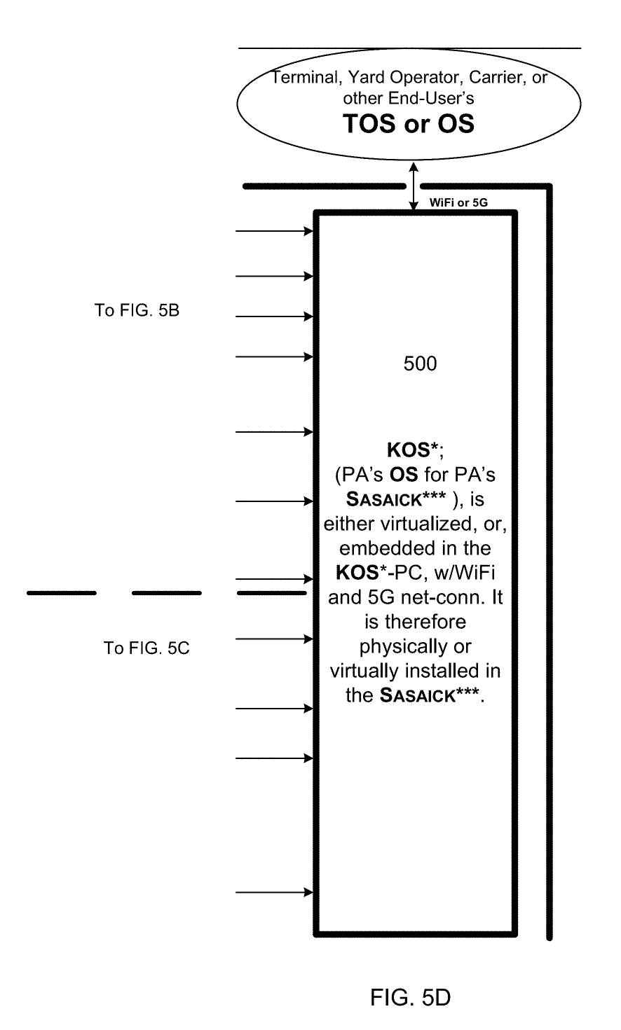

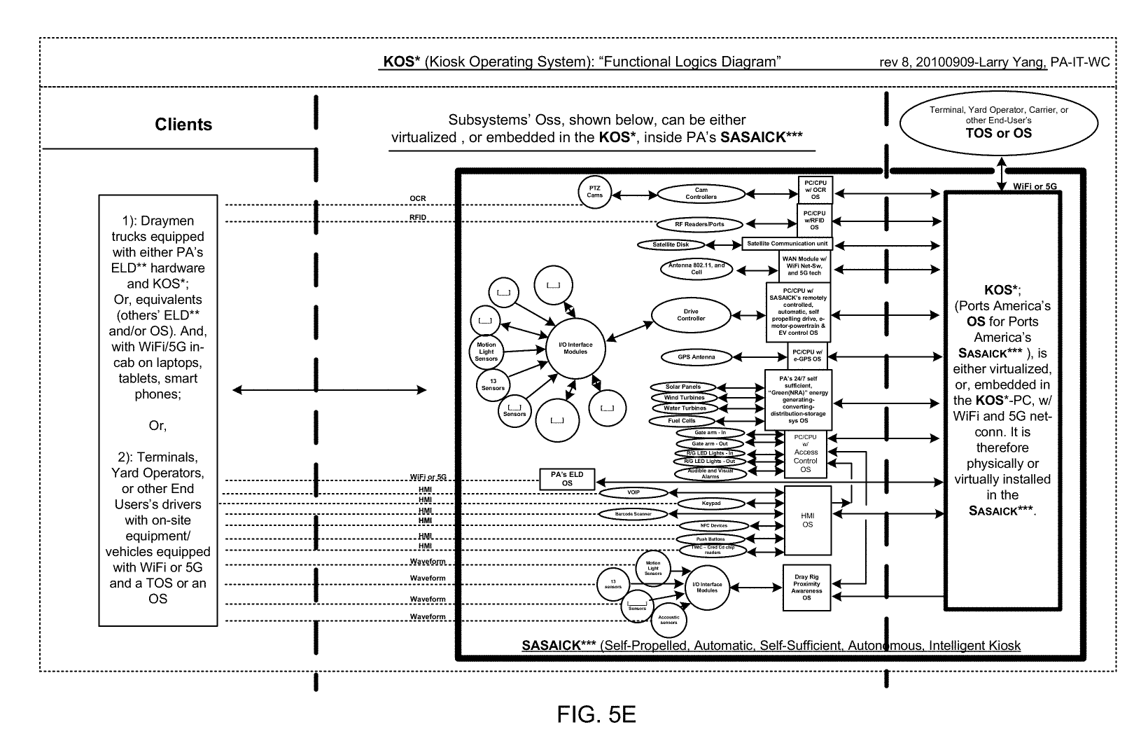

FIGS. 5A-5E are logic drawings illustrating interconnections between mobile kiosk electronic systems according to an embodiment of the invention. Specifically, FIGS. 5A-5D are sections of overall diagram FIG. 5E. FIGS. 5A-5E show interaction with remote clients (FIG. 5A), their connection to the mobile kiosk (FIGS. 5B-5C), and the interaction between the mobile kiosk and an external terminal operating system (TOS) or other operating system (OS) (FIG. 5D).

Mobile kiosk 35 may control access to locations by various vehicles. As shown in detail in FIG. 5A, the vehicles may include draymen trucks or other vehicles based away from the area under control (e.g., the port or terminal). These external vehicles 502 may be equipped with electronic logging device (ELD) hardware and software which may include hardware and software configured to interact with a kiosk operating system (KOS) of mobile kiosk 35. The external vehicles may also be equipped with communications hardware and software (e.g., WiFi, 5G, etc.) embodied in one or more computing devices (e.g., laptops, tablets, smartphones, etc.). The vehicles may include on-site equipment (e.g., terminal operators, yard operators, or other on-site personnel's vehicles). The on-site vehicles 504 may be equipped with communications hardware and software (e.g., WiFi, 5G, etc.) embodied in one or more computing devices (e.g., laptops, tablets, smartphones, etc.).

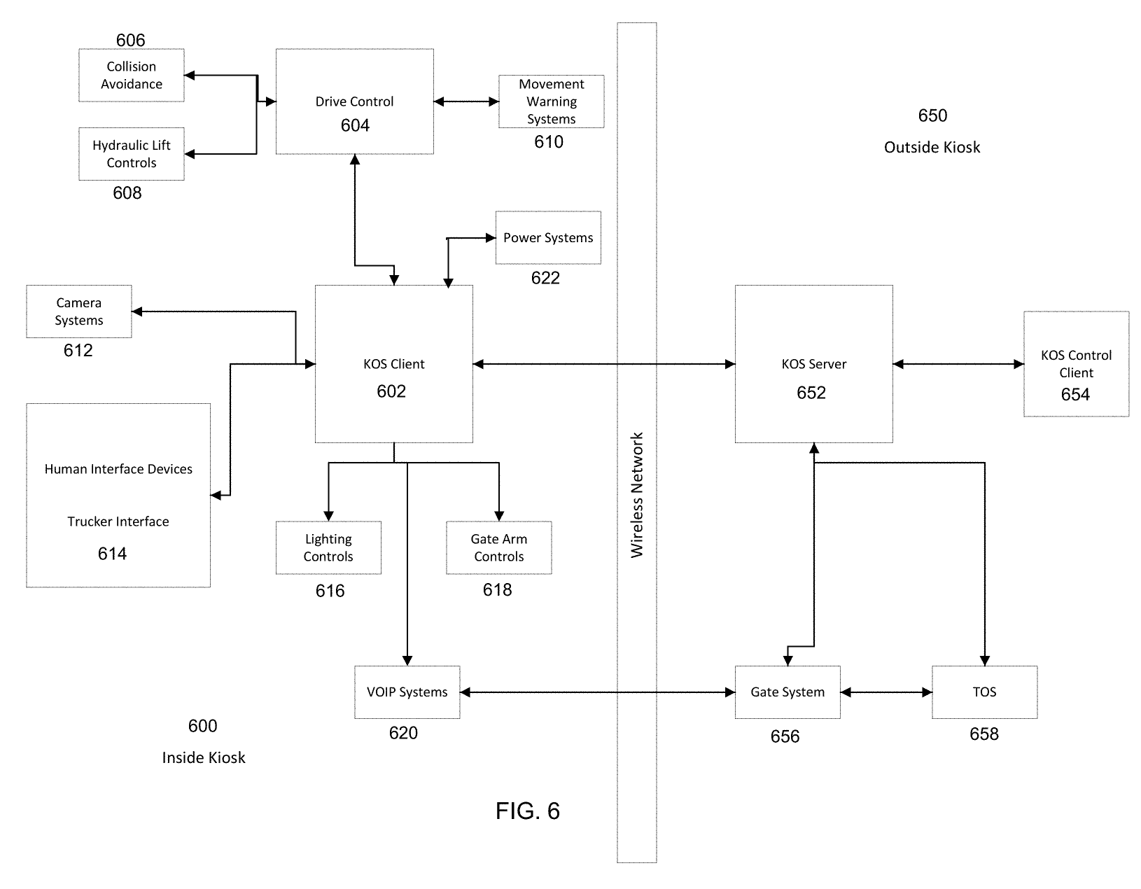

As shown in detail in FIGS. 5B-5D, vehicles may communicate with mobile kiosk 35. Mobile kiosk 35 may include a KOS 500 configured to manage kiosk systems such as drive control, camera systems, interface systems, lighting controls, gate arm controls, VOIP systems, and/or power systems, as described with respect to FIG. 6 below.

Mobile kiosk 35 may facilitate communication between in-vehicle systems and/or users and KOS 500 using a variety of elements and connections. For example, mobile kiosk 35 may be configured to read characters using optical character recognition (OCR). Mobile kiosk 35 can read a TWIC or other identification document, a license plate, or some other identifier. Accordingly, mobile kiosk 35 may include camera 538 (e.g., as discussed above), camera controller 506 configured to obtain image data from camera 538, and OCR hardware and/or software 508 configured to analyze the image data to recognize characters. For example, if a TWIC identifies a user who has permission to access the controlled area, KOS 500 may detect the user's identity through analysis by OCR hardware and/or software 508 and permit access (e.g., by raising the gate).

Mobile kiosk 35 may be configured to read RFID tags. Mobile kiosk 35 can read an identification card or other identifying object equipped with an RFID tag using an RF reader 510. Mobile kiosk 35 may include RFID hardware and/or software 512 configured to analyze the data read from an RFID tag. For example, if an RFID tag identifies a user who has permission to access the controlled area, KOS 500 may detect the user's identity through analysis by RFID hardware and/or software 512 and permit access (e.g., by raising the gate).

Mobile kiosk 35 may be configured to communicate with in-vehicle ELD systems described above. For example, mobile kiosk 35 may include networking hardware and/or software 514 configured to receive data from in-vehicle ELD systems over a network (e.g., WiFi or 5G). For example, if an ELD system identifies a user who has permission to access the controlled area, KOS 500 may detect the user's identity through data received by networking hardware and/or software 514 and permit access (e.g., by raising the gate).

Mobile kiosk 35 may include human-machine interface (HMI) hardware and/or software 516 configured to operate one or more HMI elements 518 (e.g., VOIP, key pad, barcode scanner, NFC device, pushbuttons, and/or card readers as discussed above). A user may be able to enter identifying information using HMI elements 518. KOS 500 may evaluate the entered information and, if the user has entered information identifying them as permitted to access the controlled area, permit access (e.g., by raising the gate).

Mobile kiosk 35 may include proximity awareness hardware and/or software 520 configured to automatically detect vehicles using I/O elements 522 (e.g., motion sensors, light sensors, IR sensors, magnetic sensors, and/or acoustic sensors). In some embodiments, proximity awareness hardware and/or software 520 may detect a vehicle using I/O elements 522, and KOS 500 may permit access (e.g., by raising the gate) or perform some other action (e.g., activate audible or visual alarms).

As discussed above, KOS 500 may operate the gate and/or activate lights and/or alarms. Accordingly, mobile kiosk 35 may include access control hardware and/or software 524 configured to receive commands from KOS 500 and control the gate arm, lights, and alarms.

As discussed above, mobile kiosk 35 may include power control systems. In some embodiments, power control systems may include power control hardware and/or software 526 configured to control operation of and/or direct power from power generation elements 530 such as the solar panels, wind turbines, water turbines, fuel cells, etc. based on commands from KOS 500.

As discussed above, mobile kiosk 35 may include communications control systems. In some embodiments, communications control systems may include communications control hardware and/or software 528 configured to control operation of and/or receive data from communications elements 532 such as the GPS antenna, network antenna(s), satellite dish, etc. based on commands from KOS 500.

As discussed above, mobile kiosk 35 may be configured to drive and reposition itself in new locations. Accordingly, mobile kiosk 35 may include drive control hardware and/or software 534 configured to control and/or receive information from drive I/O elements 536. For example, based on commands from KOS 500, drive control hardware and/or software 534 may operate drive motors, brakes, horns, lights, etc. Drive control hardware and/or software 534 may receive environmental information from motion sensors, light sensors, IR sensors, magnetic sensors, etc. Sensor data may be used by KOS 500 and/or drive control hardware and/or software 534 for decision-making regarding collision avoidance and/or positioning. Drive control hardware and/or software 534 may allow mobile kiosk 35 to operate as a self-propelled, automatic, self-sufficient, autonomous, intelligent kiosk (SASAICK).

FIG. 6 is a block diagram of mobile kiosk circuitry 600 and external kiosk operating system circuitry 650 according to an embodiment of the invention. Mobile kiosk circuitry 600 may comprise one or more processors configured to provide a KOS client 602. KOS client 602 may manage kiosk systems such as drive control 604, camera systems 612, interface systems 614, lighting controls 616, gate arm controls 618, VOIP systems 620, and/or power systems 622. Drive control 604, in turn, may manage drive-specific systems such as collision avoidance 606, hydraulic lift controls 608, and/or movement warning systems 610. KOS client 602 may communicate with individual kiosk systems using one or more application programming interfaces (APIs) specific to each individual kiosk system.

KOS client 602 may use communications equipment (e.g., 802.11 and/or Cellular/LTE/4G/5G as described above) to communicate with KOS server 652, for example using an API. KOS server 652 may comprise one or more processors configured to, for example, direct movement of the mobile kiosk and/or direct traffic control operations performed by the mobile kiosk. KOS server 652 may communicate with KOS client 602, KOS control client 654, gate system 656, and/or TOS 658. KOS server 652 may be physically separate from the mobile kiosk. In some embodiments, one or more kiosk systems 600 and/or outside kiosk systems 650 may comprise off the shelf components such as the BlueSky Solar charge controllers 3000i and IPN-REMOTE.

KOS client 602 may receive power status data, power consumption data, power collection data, and/or power capacity data from power systems 622. The data may describe the current power status as reported by the charging system, for example. KOS client 602 may report this data to KOS server 652. In some embodiments, KOS server 652 may process this data to determine and send additional commands to KOS client 602. KOS client 602 may send power control commands to power systems 622. These commands may include system on/off, change power source, and/or shut off load commands. For example, KOS server 652 may send instructions to issue a power control command to KOS client 602. Such commands may be ordered by a user and/or may be automatically generated by KOS server 652.

KOS client 602 may receive video stream data and/or pan-tilt-zoom (PTZ) responses from camera systems 612. KOS client 602 may report this data to KOS server 652. In some embodiments, KOS server 652 may process this data to determine and send additional commands to KOS client 602. KOS client 602 may send PTZ and/or camera programming commands to camera systems 612. For example, camera commands may include Up/Down/Left/Right/Zoom In/Zoom Out. For example, KOS server 652 may send instructions to issue a camera command to KOS client 602. Such commands may be ordered by a user and/or may be automatically generated by KOS server 652.

KOS client 602 may receive input data from human interface device (HID) systems 614. KOS client 602 may output this data to KOS server 652. In some embodiments, KOS server 652 may process this data to determine and send additional commands to KOS client 602.

KOS client 602 may send lighting on/off commands to lighting controls 616. For example, KOS server 652 may send instructions to issue a lighting command to KOS client 602. Such commands may be ordered by a user and/or may be automatically generated by KOS server 652.

KOS client 602 may send gate open/close commands to gate arm controls 618. For example, KOS server 652 may send instructions to issue a gate command to KOS client 602. Such commands may be ordered by a user and/or may be automatically generated by KOS server 652.

KOS client 602 may direct VOIP systems 620 to establish and/or disconnect connections to gate system servers 656. For example, in response to a user attempting to communicate at the kiosk using the VOIP phone, KOS client 602 may command VOIP systems 620 to establish a connection. When the user hangs up the phone, KOS client 602 may command VOIP systems 620 to terminate the connection. In some cases, KOS server 652 may send instructions to establish or terminate a VOIP connection to KOS client 602 (e.g., when a user away from the kiosk is attempting to call the kiosk). Such commands may be ordered by a user and/or may be automatically generated by KOS server 652.

KOS client 602 may communicate with drive control 604. Drive control 604 may manage collision avoidance systems 606, hydraulic lift control systems 608, and/or movement warning systems 610, for example.

KOS client 602 may send drive commands and/or other data to drive control 604. KOS client 602 may send directional movement commands, drive system on/off commands, override commands, geolocation data, path data, destination data, and/or emergency stop commands. For example, KOS server 652 may send drive instructions to KOS client 602. Such commands may be ordered by a user and/or may be automatically generated by KOS server 652. As noted above, KOS client 602 may communicate with individual kiosk systems using one or more APIs specific to each individual kiosk system (e.g., an API for drive control 604) in order to deliver the commands to drive control 604.

Drive control 604 may use commands from KOS client 602 and collision avoidance data from collision avoidance system 606 (e.g., sensor data about objects in kiosk path) to maneuver the kiosk. When the kiosk is in place, drive control 604 may direct hydraulic lift controls 608 to lift the kiosk off its wheels using a hydraulic lift system to reduce strain on the wheels and/or provide kiosk stability. Drive control 604 may direct movement warning systems 610 to generate audible and/or visual movement warnings while the kiosk is in motion, for example sounding alerts and/or flashing lights.

Drive control 604 may send feedback to KOS client 602. For example, feedback may include drive system alerts, status, failures, location data, and/or subsystem status. For example, in case of alert or failure that could pose a risk to one or more of the device systems, KOS client 602 may would shut down the drive system and notify KOS server 652.

The TOS may be a third party system specific to the location where the KOS is deployed. The TOS has functions that may vary depending on TOS vendor and location. The TOS may not be required for KOS system to function. The KOS Control Client may comprise an end-user client interface which may include software or hardware (e.g., a console) to allow a user to control functions of the KOS that may not be controlled automatically by the server.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A mobile kiosk comprising:
a circuit comprising:
a battery;
a charge controller configured to supply current to the battery;
equipment coupled to the battery; and
a wireless communication system coupled to the battery and configured to receive commands to control the equipment;
an enclosed space housing at least a portion of the circuit; and
a base supporting the enclosed space and configured to be movable.

2. The mobile kiosk of claim 1, wherein the enclosed space is divided into two or more sections.

3. The mobile kiosk of claim 2, wherein one section houses at least the battery and the charge controller.

4. The mobile kiosk of claim 2, wherein one section houses at least the wireless communication system.

5. The mobile kiosk of claim 1, further comprising at least one door providing access to the enclosed space.

6. The mobile kiosk of claim 1, wherein the enclosed space further houses a ballast.

7. The mobile kiosk of claim 1, wherein the base comprises at least one lifting point configured to allow the mobile kiosk to be lifted.

8. The mobile kiosk of claim 1, further comprising at least one power source coupled to the charge controller and configured to generate the current.

9. The mobile kiosk of claim 8, further comprising at least one mounting point for the at least one charge source.

10. The mobile kiosk of claim 1, further comprising an inverter coupled to the battery and configured to receive current from at least one external power source and supply the received current to the battery.

11. The mobile kiosk of claim 1, wherein the circuit further comprises a load relay configured to supply current from the battery to the gate equipment.

12. The mobile kiosk of claim 1, further comprising at least one mounting point for a ladder.

13. A mobile kiosk comprising:
a power source;
a kiosk operating system computer coupled to the power source;
a drive system coupled to the power source; and
a drive controller coupled to the kiosk operating system computer, the drive controller, and the power source, the drive controller configured to drive the mobile kiosk by controlling the drive system; and
wherein the kiosk operating system computer is configured to automatically control the drive controller to move the mobile kiosk.

14. The mobile kiosk of claim 13, wherein the drive system comprises:
a collision avoidance system configured to sense obstacles;
a movement warning system configured to generate an alert when the mobile kiosk is moving;
a hydraulic lift system configured to stabilize the mobile kiosk when the mobile kiosk is not moving; or
a combination thereof.

15. The mobile kiosk of claim 13, further comprising:
a sensor coupled to the kiosk operating system computer;
a human interface device coupled to the kiosk operating system computer;
a lighting system coupled to the kiosk operating system computer;
a gate arm control system coupled to the kiosk operating system computer; or
a combination thereof.

16. The mobile kiosk of claim 15, further comprising a communication system coupled to the kiosk operating system computer, wherein the kiosk operating system computer is configured to transmit one or more of sensor data, human interface data, lighting system data, gate arm data, power source data, and drive system data.

17. The mobile kiosk of claim 15, further comprising a communication system coupled to the kiosk operating system computer, wherein the kiosk operating system computer is configured to receive one or more of a sensor command, a human interface command, a lighting system command, a gate arm command, a power source command, and a drive system command.
